(19) United States
(12) Patent Application Publication
(10) Pub. No.: US 2025/0117667 A1
(43) Pub. Date: Apr. 10, 2025

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Eiji YUMOTO, Tokyo (JP); Masahiro Hayashitani, Tokyo (JP); Yusuke Ito, Tokyo (JP); Yuki Kosaka, Tokyo (JP)

(73) Assignee: NEC Corporation, Minato-ku, Tokyo (JP)

(21) Appl. No.: 18/729,404

(22) PCT Filed: Jan. 31, 2022
(86) PCT No.: PCT/JP2022/003501

§ 371 Date: Jul. 16, 2024

(51) Int. Cl. G06N 3/096

(52) U.S. Cl. CPC G06N 3/096

(57) ABSTRACT

In an information processing device, an information acquisition means acquires a first data subset created by extracting a partial data group included in a first data set, a first distance corresponding to a distance between the first data subset and the first data set, a second data subset created by extracting a partial data group included in a second data set, and a second distance corresponding to a distance between the second data subset and the second data set. An information generation means calculates a third distance corresponding to a distance between the first data subset and the second data subset, and to generate an estimation distance information which is information capable of estimating a fourth distance corresponding to a distance between the first data set and the second data set based on the first distance, the second distance, and the third distance.

### TECHNICAL FIELD

The present disclosure relates to a technology of transfer learning.

### BACKGROUND ART

Conventionally, a technique related to transfer learning that is performed to use an existing learning model trained for use in a predetermined application in a new application different from the predetermined application is known.

In the transfer learning, a new data set is used to re-train the existing learning model so that the existing learning model can be adapted to the new application.

Furthermore, in the transfer learning, for example, in order to ensure accuracy when using the existing learning model in the new application, it is desirable that matching is performed so that a distance between a previous data set used during a (most recent) training prior to the re-training and the new data set used during the re-training is closer.

On the other hand, for example, Non-Patent Document 1 discloses a technique for calculating a distance between two data sets to which labels are assigned.

### PRECEDING TECHNICAL REFERENCES

### Non-Patent Document

Non-Patent Document 1: David Alvarez-Melis, and Nicolo Fusi, “Geometric Dataset Distances via Optimal Transport”, [online], arXiv on Feb. 7, 2020, [search on Dec. 6, 2021], internet <UTRL:https://arxiv.org/pdf/2002.02923.pdf>

### SUMMARY

### Problem to be Solved by the Invention

However, according to a method disclosed in Non-Patent Document 1, it is not possible to calculate a distance without using all data included in a previous data set and all data included in a new data set. Therefore, for example, in a case where a technique disclosed in Non-Patent Document 1 is applied to matching of a data set for transfer learning, an excessive load may occur in a process related to the matching.

It is one object of the present disclosure to provide an information processing device capable of reducing a load which occurs in a process for matching a data set for the transfer learning.

### Means for Solving the Problem

According to an example aspect of the present disclosure, there is provided an information processing device including:
an information acquisition means configured to acquire a first data subset created by extracting a partial data group included in a first data set, a first distance corresponding to a distance between the first data subset and the first data set, a second data subset created by extracting a partial data group included in a second data set, and a second distance corresponding to a distance between the second data subset and the second data set; and
an information generation means configured to calculate a third distance corresponding to a distance between the first data subset and the second data subset, and to generate an estimation distance information which is information capable of estimating a fourth distance corresponding to a distance between the first data set and the second data set based on the first distance, the second distance, and the third distance.

According to another example aspect of the present disclosure, there is provided an information processing method including:
acquiring a first data subset created by extracting a partial data group included in a first data set, a first distance corresponding to a distance between the first data subset and the first data set, a second data subset created by extracting a partial data group included in a second data set, and a second distance corresponding to a distance between the second data subset and the second data set; and
calculating a third distance corresponding to a distance between the first data subset and the second data subset, and generating an estimation distance information which is information capable of estimating a fourth distance corresponding to a distance between the first data set and the second data set based on the first distance, the second distance, and the third distance.

According to a further example aspect of the present disclosure, there is provided a recording medium storing a program, the program causing a computer to perform a process including:
acquiring a first data subset created by extracting a partial data group included in a first data set, a first distance corresponding to a distance between the first data subset and the first data set, a second data subset created by extracting a partial data group included in a second data set, and a second distance corresponding to a distance between the second data subset and the second data set; and
calculating a third distance corresponding to a distance between the first data subset and the second data subset, and generating an estimation distance information which is information capable of estimating a fourth distance corresponding to a distance between the first data set and the second data set based on the first distance, the second distance, and the third distance.

### Effect of the Invention

According to the present disclosure, it is possible to reduce a load which occurs in a process of matching data sets for transfer learning.

### BRIEF DESCRIPTION OF THE DRAWINGS

FIG. 1 is a diagram illustrating an example of a data process system including a server device according to a first example embodiment.

FIG. 2 is a block diagram illustrating a hardware configuration of the server device according to the first example embodiment.

FIG. 3 is a diagram illustrating a functional configuration of the server device according to the first example embodiment.

FIG. 4 is a flowchart for explaining a process performed by the server device according to the first example embodiment.

FIG. 5 is a block diagram illustrating a functional configuration of a server device according to a second example embodiment.

FIG. 6 is a flowchart for explaining a process performed by an information processing device according to the second example embodiment.

### EXAMPLE EMBODIMENTS

In the following, example embodiments will be described with reference to the accompanying drawings.

### First Example Embodiment

### [System Configuration]

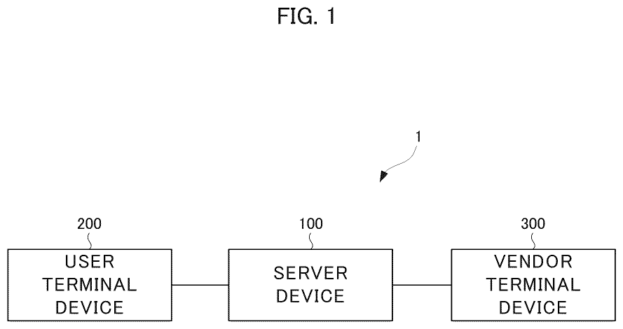

FIG. 1 is a diagram illustrating an example of a configuration of a data processing system including a server device according to a first example embodiment.

The data processing system 1 includes a server device 100, a user terminal device 200, and a vendor terminal device 300, as illustrated in FIG. 1.

The server device 100 is configured to be able to communicate with the user terminal device 200 and the vendor terminal device 300. Moreover, the server device 100 performs a process (described later in detail) related to matching between a data set transmitted from the user terminal device 200 and a data set transmitted from the vendor terminal device 300. In addition, the server device 100 transmits a process result acquired through the process related to the matching with respect to the user terminal device 200 from which the data set is transmitted. Furthermore, the server device 100 transmits, as necessary, the process result acquired through a matching process or the like with respect to the vendor terminal device 300 from which the data set is transmitted.

The user terminal device 200 is associated with a user who desires to purchase a data set with labels which is used for transfer learning of a learning model (hereinafter, abbreviated as “for the transfer learning”), Moreover, the user terminal device 200 includes a function for communicating with the server device 100, a function for inputting information to be transmitted to the server device 100, and a function for displaying information received from the server device 100. In detail, the user terminal device 200 is formed by a device such as a personal computer, a smartphone, a tablet type computer, or the like, for instance.

The vendor terminal device 300 is associated with a vendor who desires to sell a data set for the transfer learning. Moreover, the vendor terminal device 300 includes a function for communicating with the server device 100, a function for inputting information to be transmitted to the server device 100, and a function for displaying information received from the server device 100. In detail, the vendor terminal device 300 is formed by a device such as a personal computer, a smartphone, a tablet type computer, or the like, for instance.

### [Hardware Configuration]

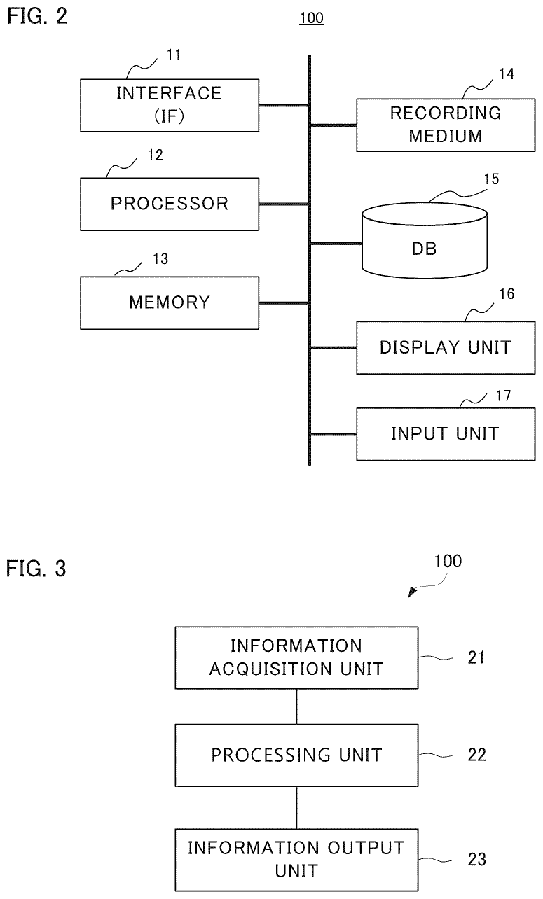

FIG. 2 is a block diagram illustrating a hardware configuration of the server device according to the first example embodiment. As illustrated, the server device 100 includes an interface (IF) 11, a processor 12, a memory 13, a recording medium 14, a database (DB) 15, a display unit 16, and an input unit 17.

The IF 11 inputs and outputs data to and from an external device. Specifically, for instance, a data set used in the matching process is input and output through the IF 11. In addition, information indicating the process result of the matching process and other information are output to the external device through the IF 11.

The processor 12 is a computer such as a CPU (Central Processing Unit) or a GPU (Graphics Processing Unit) and controls the entire server device 100 by executing programs prepared in advance. Specifically, the processor 12 performs processes and the like related to the matching described below.

The memory 13 is formed by a ROM (Read Only Memory) and a RAM (Random Access Memory). The memory 13 is also used as a working memory during executions of various processes by the processor 12.

The recording medium 14 is a non-volatile and non-transitory recording medium such as a disk-shaped recording medium or a semiconductor memory and is formed to be detachable from the server device 100. The recording medium 14 records various programs executed by the processor 12. When the server device 100 executes the various processes, the programs recorded in the recording medium 14 are loaded into the memory 13 and executed by the processor 12.

The database 15 stores data sets or the like input through the IF 11. In addition, the database 15 stores each process result and the like acquired by a process according to the matching described below.

The display unit 16 is formed by a display device such as a liquid crystal monitor, for instance. In addition, the display unit 16 displays information such as the process result of the process related to the matching as necessary.

The input unit 17 includes an input device such as a keyboard, a mouse, and a touch panel, for instance.

### [Function Configuration]

FIG. 3 is a diagram illustrating a functional configuration of the server device according to the first example embodiment. As illustrated in FIG. 3, the server device 100 includes an information acquisition unit 21, a processing unit 22, and an information output unit 23.

The information acquisition unit 21 acquires a user data subset UDS and a distance DTU which are output from the user terminal device 200. Moreover, the information acquisition unit 21 acquires a vendor data subset VDS and a distance DTV output from the vendor terminal device 300. Note that the user data subset UDS, the distance DTU, the vendor data subset VDS, and the distance DTV will be described later.

The processing unit 22 performs the process according to the matching described below using the user data subset UDS and the distance DTU, and the vendor data subset VDS and the distance DTV. The processing unit 22 generates estimation distance information EDJ including information capable of estimating a distance between a user data set UDA corresponding to the entire data set for the transfer learning possessed by the user and a vendor data set VDA corresponding to the entire data set for the transfer learning possessed by the vendor as the process result of the process related to the matching. Note that a detailed description of the estimation distance information EDJ will be described later.

The information output unit 23 outputs information such as the estimation distance information EDJ to the user terminal device 200. Moreover, the information output unit 23 outputs the information such as the estimation distance information EDJ to the vendor terminal device 300 as needed.

### [Process Related To Matching]

Next, a specific example of the process related to the matching will be described. In the following explanation, it is assumed that the user data subset UDS created by extracting a partial data group included in the user data set UDA is prepared in advance in the user terminal device 200 (the user holds the user data subset UDS in advance). In the following explanation, it is assumed that the vendor data subset VDS created by extracting a partial data group included in the vendor data set VDA is prepared in advance in the vendor terminal device 300 (the vendor holds the vendor data subset VDS in advance). That is, in the present example embodiment, the user data subset UDS can be represented as a partial data set of the user data set UDA. Furthermore, the present example embodiment, the vendor data subset VDS can be expressed as a partial data set of the vendor data set VDA. In the following, a case where the vendor data subset VDS is sold as a data set for the transfer learning will be described as an example.

### Specific Example 1

The user terminal device 200 calculates the distance DTU between the user data subset UDS and the user data set UDA in response to an instruction of the user. Moreover, the user terminal device 200 transmits the user data subset UDS and the distance DTU to the server-device 100 in response to an instruction of the user. Furthermore, the user terminal device 200 transmits a threshold value δ determined by the user to the server device 100.

The vendor terminal device 300 calculates the distance DTV between the vendor data subset VDS and the vendor data set VDA in response to an instruction of the vendor. Moreover, the vendor terminal device 300 transmits the vendor data subset VDS and the distance DTV to the server device 100 in response to an instruction of the vendor.

The information acquisition unit 21 acquires the user data subset UDS, the distance DTU and the threshold value δ output from the user terminal device 200. Moreover, the information acquisition unit 21 acquires the vendor data subset VDS and the distance DTV which are output from the vendor terminal device 300.

The processing unit 22 calculates a difference value ε by applying the distance DTU and the distance DTV to the following formula (1):

$$\begin{matrix}[ Formula 1 ] & \\ ε = D T U + D T V . & ( 1 )\end{matrix}$$

Here, the difference value ε can be expressed based on a triangular inequality satisfied by the distance between the data sets, as in the following formula (2). Note that in the following formula (2), DTA denotes the distance between the user data set UDA and the vendor data set VDA.

$$\begin{matrix}[ Formula 2 ] & \\ \vert DTA - DTS \vert ≦ ε & ( 2 )\end{matrix}$$

Moreover, the above formula (2) indicates the same value as the following formula (3). In the formula (2) and the formula (3), DTS denotes the distance between the user data subset UDS and the vendor data subset VDS. Also, the distance DTS is calculated by the processing unit 22.

$$\begin{matrix}[ Formula 3 ] & \\ DTS - ε ≦ D T A ≦ D T S + ε & ( 3 )\end{matrix}$$

That is, according to the above formulae (2) and (3), the difference value E corresponds to an index representing a magnitude of the difference between the distance DTS and the distance DTA. Therefore, for instance, when the difference value ε is calculated as a relatively small value, it can be estimated that a combination of the user data subset UDS and the vendor data subset VDS which have a high quality is acquired so that a correlation between the distance DTS and the distance DTA is strengthened. Moreover, for instance, when the difference value ε is calculated as a relatively large value, it can be estimated that a combination of the user data subset UDS and the vendor data subset VDS which have a low quality is acquired so that the correlation between the distance DTS and the distance DTA is weakened.

By comparing the difference value ε calculated by the above formula (1) with the threshold value δ determined by the user, the processing unit 22 determines whether or not a level of the correlation between the distance DTS and the distance DTA has reached a level desired by the user.

For instance, when detecting that the difference value ε is equal to or greater than the threshold value δ, the processing unit 22 determines that the level of the correlation between the distance DTS and the distance DTA does not reach a level desired by the user. In a case where such the determination is performed, for instance, after a message is generated by the processing unit 22 to prompt at least one of the user or the vendor to re-create the data subset and the message is output from the information output unit 23, the above-described process is performed again. An output destination of the above-described message may be set to at least one of the user terminal device 200 or the vendor terminal device 300.

Moreover, for instance, when detecting that the difference value ε is less than the threshold value δ, the processing unit 22 determines that the level of the correlation between the distance DTS and the distance DTA has reached the level desired by the user. Then, in a case where such determination is performed, the estimation distance information EDJ corresponding to the information in which the calculation results of the difference value s and the distance DTS are applied to the formula (3) is generated by the processing unit 22, and also, the generated estimation distance information EDJ is output from the information output unit 23 to the user terminal device 200. Note that the output destination of the estimation distance information EDJ described above may be both the user terminal device 200 and the vendor terminal device 300.

The user terminal device 200 transmits information indicating whether or not the vendor data subset VDS corresponding to the estimation distance information EDJ is purchased, to the server device 100 in response to an instruction of the user.

In a case where the user purchases the vendor data subset VDS, the processing unit 22 sets the vendor data subset VDS to a downloadable state after a payment process is completed by the user.

In addition, in a case where the user does not purchase the vendor data subset VDS, for instance, after a message is generated by the processing unit 22 to prompt at least one of the user or the vendor to re-create the data subset and the message is output from the information output unit 23, the process described above is performed again. Note that the output destination of the above-described message may be set to at least one of the user terminal device 200 or the vendor terminal device 300.

According to the process according to the matching described above, it is possible to acquire the estimation distance information EDJ which is information capable of estimating the distance DTA without calculating the distance DTA, and also to present the estimation distance information EDJ to the user (and the vendor). Moreover, according to the process related to the matching described above, by referring to the estimation distance information EDJ displayed on the user terminal device 200, the user can purchase the vendor data subset VDS having a quality corresponding to the threshold value δ.

### Specific Example 2

The vendor terminal device 300 calculates the distance DTV between the vendor data subset VDS and the vendor data set VDA in response to an instruction of the vendor. Also, the vendor terminal device 300 transmits the vendor data subset VDS and the distance DTV to the server device 100 in response to an instruction of the vendor. Furthermore, by performing the process in advance by each of a plurality of vendors, a plurality of combinations of the vendor data subsets VDS and the distances DTV respective to the plurality of vendors are stored in the server device 100.

The user terminal device 200 calculates the distance DTU between the user data subset UDS and the user data set UDA in response to an instruction of the user. The user terminal device 200 transmits the user data subset UDS and the distance DTU to the server device 100 in response to an instruction of the user.

The information acquisition unit 21 acquires the user data subset UDS and the distance DTU which are output from the user terminal device 200.

The processing unit 22 acquires one combination of a vendor data subset VDSC and a distance DTVC, which is not used for calculating the formulae (1) and (3) described above, from among the plurality of combinations of the vendor data subsets VDS and the distances DTV stored in the server device 100.

The processing unit 22 calculates the difference value ε by applying the distance DTU to the above formula (1) and also applying the distance DTVC to the distance DTV to the above formula (1). The processing unit 22 generates the estimation distance information EDJ corresponding to information in which a calculation result of the difference value ε to the formula (3) described above and a calculation result of a distance between the user data subset UDS and the vendor data subset VDSC to the distance DTS to the formula (3) described above. After the estimation distance information EDJ is output from the information output unit 23, the estimation distance information EDJ is displayed in the user terminal device 200.

The user terminal device 200 transmits information indicating whether or not the vendor data subset VDSC corresponding to the estimation distance information EDJ is purchased, to the server device 100 in response to an instruction of the user.

In a case where the user purchases the vendor data subset VDSC, after the payment process is completed by the user, the processing unit 22 sets the vendor data subset VDSC to the downloadable state.

In addition, in a case where the user does not purchase the vendor data subset VDSC, the processing unit 22 performs the process related to the generation of the estimation distance information EDJ again for another vendor data subset VDS which is different from the vendor data subset VDSC.

According to the process related to the matching described above, it is possible to acquire the estimation distance information EDJ which is information capable of estimating the distance DTA without calculating the distance DTA, and also to present the estimation distance information EDJ to the user. Moreover, according to the process related to the matching described above, the user can purchase the vendor data subset VDS having the quality according to subjectivity of the user by referring to the estimation distance information EDJ displayed on the user terminal device 200.

### (Process Flow)

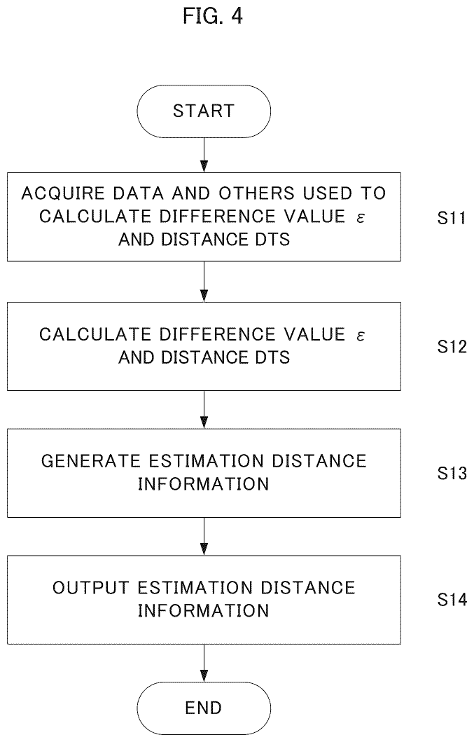

Next, a flow of a process according to the matching performed in the server device will be described. In the following, while a common process performed in both the specific examples 1 and 2 described above will be mainly explained, explanations of a unique process performed in either the specific examples 1 or 2 described above will be omitted as appropriate. FIG. 4 is a flowchart illustrating the process related to the matching performed in the server device according to the first example embodiment.

The information acquisition unit 21 performs a process for acquiring data and the like used to calculate the difference value ε and the distance DTS (step S11). In detail, in step S11, the information acquisition unit 21 acquires the user data subset UDS and the distance DTU output from the user terminal device 200 and also acquires the vendor data subset VDS and the distance DTV output from the vendor terminal device 300. According to the specific example 1, in step S11, the information acquisition unit 21 further acquires the threshold value δ output from the user terminal device 200. Moreover, according to the specific example 2 described above, in the step S11, before acquiring the user data subset UDS and the distance DTU, the information acquisition unit 21 acquires a plurality of sets of vendor data subset VDS and the distance DTV.

The processing unit 22 performs a process for calculating the difference value ε and the distance DTS using the data or the like acquired in step S11 (step S12). According to the specific example 2, the processing unit 22 performs a process in the step S12 with respect to one combination of the vendor data subset VDSC and the distance DTVC which are extracted (selected) from among the plurality of combinations of the vendor data subsets VDS and the distances DTV.

The processing unit 22 generates the estimation distance information EDJ by applying the difference value ε and the distance DTS which are calculated in step S12 to the above formula (3) (step S13). That is, the processing unit 22 generates, as the estimation distance information EDJ, information indicating that a lower limit value of the distance DTA is a value acquired by subtracting the difference value ε from the distance DTS and an upper limit value of the distance DTA is a value acquired by adding the difference value ε to the distance DTS. According to the specific example 1, with respect to δ>ε, the processing unit 22 performs a process of step S13. Moreover, according to the specific example 1 described above, with respect to δ≥ε, the processing unit 22 generates a message to prompt at least one of the user or the vendor to re-create the data subset, instead of the process in step S13, and performs a process for setting the output destination of the generated message. The above-described message is output to the device (at least one of the user terminal device 200 or the vendor terminal device 300) which is set as the output destination through the information output unit 23.

The information output unit 23 outputs the estimation distance information EDJ to the user terminal device 200 (step S14). According to the specific example 1, the information output unit 23 may output the estimation distance information EDJ to both the user terminal device 200 and the vendor terminal device 300 in step S14. Moreover, according to the specific example 1, when the information indicating that the user does not purchase the vendor data subset VDS is acquired after a process of step S14 is performed, the process after step S1 is performed again. Furthermore, according to the above-described specific example 2, when the information indicating that the user does not purchase the vendor data subset V/DSC is acquired after the process of step S14, the process after step S12 is performed again.

As described above, according to the present example embodiment, even in a case where the user data set UDA and the vendor data set VDA are not disclosed (even in a case the user data set UDA and the vendor data set VDA are not transmitted to the server device 100), it is possible to acquire the estimation distance information EDJ that is the information capable of estimating the distance DTA, and it is possible to present the estimation distance information EDJ to the user (and the vendor). Therefore, according to the present example embodiment, it is possible to reduce the load which occurs in the process related to the matching of the data set for the transfer learning. Moreover, according to the present example embodiment, it is possible to estimate the distance between the data sets by providing only the partial data sets to the third party.

### Second Example Embodiment

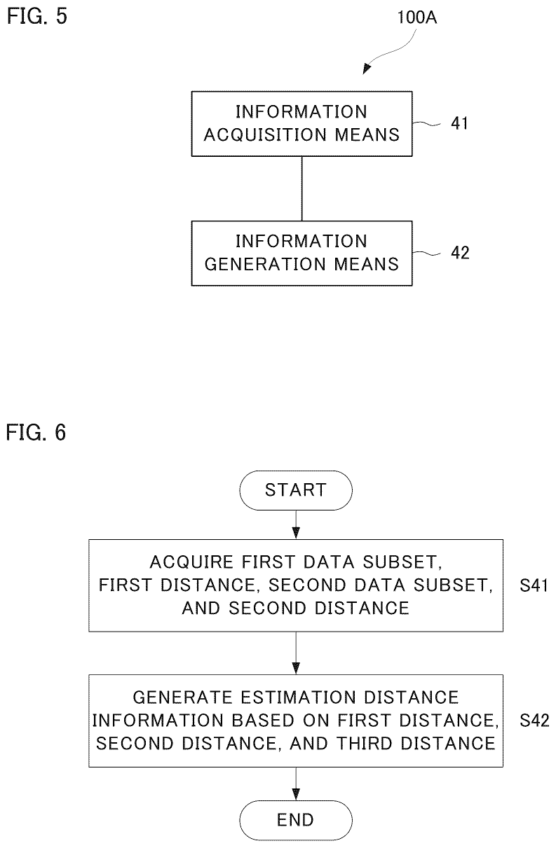

FIG. 5 is a block diagram illustrating a functional configuration of a server device according to a second example embodiment.

The data process system 1 according to the present example embodiment includes a server device 100A, the user terminal device 200, and the vendor terminal device 300. Moreover, the server device 100A includes the same hardware configuration as the server device 100. Furthermore, the server device 100A includes an information acquisition means 41 and an information generation means 42 as depicted in FIG. 5.

FIG. 6 is a flowchart for explaining a process performed in the information process device according to the second example embodiment.

The information acquisition means 41 acquires a first data subset created by extracting a partial data group included in the first data set, a first distance corresponding to a distance between the first data subset and the first data set, a second data subset created by extracting a partial data group included in the second data set, and a second distance corresponding to a distance between the second data subset and the second data set (step S41).

The information generating means 42 calculates a third distance corresponding to the distance between the first data subset and the second data subset, and generates the estimation distance information which is information capable of estimating a fourth distance corresponding to a distance between the first data set and the second data set, based on the first distance, the second distance, and the third distance (step S42).

According to the present example embodiment, it is possible to reduce the load which occurs in the process related to the matching of the data set for the transfer learning.

A part or all of the example embodiments described above may also be described as the following supplementary notes, but not limited thereto.

### Supplementary Note 1

An information processing device comprising:
an information acquisition means configured to acquire a first data subset created by extracting a partial data group included in a first data set, a first distance corresponding to a distance between the first data subset and the first data set, a second data subset created by extracting a partial data group included in a second data set, and a second distance corresponding to a distance between the second data subset and the second data set; and
an information generation means configured to calculate a third distance corresponding to a distance between the first data subset and the second data subset, and to generate an estimation distance information which is information capable of estimating a fourth distance corresponding to a distance between the first data set and the second data set, based on the first distance, the second distance, and the third distance.

### Supplementary Note 2

The information processing device according to supplementary note 1, wherein the information generation means calculates a difference value corresponding to an index which represents a magnitude of a difference between the third distance and the fourth distance by calculating the first distance and the second distance.

### Supplementary Note 3

The information processing device according to supplementary note 1, wherein the information generation means generates, as the estimation distance information, information indicating that a lower limit value of the fourth distance is a value acquired by subtracting the difference value from the third distance and an upper limit value of the fourth distance is a value acquired by adding the difference value to the third distance.

### Supplementary Note 4

The information processing device according to supplementary note 2 or 3, wherein the information generation means generates when the difference value is less than a threshold value, and generates a message to prompt at least one of a person who owns the first data subset or a person who owns the second data subset to re-create a data subset when the difference value is equal to or greater than the threshold value.

### Supplementary Note 5

An information processing method comprising:
acquiring a first data subset created by extracting a partial data group included in a first data set, a first distance corresponding to a distance between the first data subset and the first data set, a second data subset created by extracting a partial data group included in a second data set, and a second distance corresponding to a distance between the second data subset and the second data set; and
calculating a third distance corresponding to a distance between the first data subset and the second data subset, and generating an estimation distance information which is information capable of estimating a fourth distance corresponding to a distance between the first data set and the second data set based on the first distance, the second distance, and the third distance.

### Supplementary Note 6

A recording medium storing a program, the program causing a computer to perform a process comprising:
acquiring a first data subset created by extracting a partial data group included in a first data set, a first distance corresponding to a distance between the first data subset and the first data set, a second data subset created by extracting a partial data group included in a second data set, and a second distance corresponding to a distance between the second data subset and the second data set; and
calculating a third distance corresponding to a distance between the first data subset and the second data subset, and generating an estimation distance information which is information capable of estimating a fourth distance corresponding to a distance between the first data set and the second data set based on the first distance, the second distance, and the third distance.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

12 Processor
21 Information acquisition unit
22 Processing unit
23 Information output unit

What is claimed is:

1. An information processing device comprising:
at least one memory configured to store instructions; and
at least one processor configured to execute the instructions to:
acquire a first data subset created by extracting a partial data group included in a first data set, a first distance corresponding to a distance between the first data subset and the first data set, a second data subset created by extracting a partial data group included in a second data set, and a second distance corresponding to a distance between the second data subset and the second data set; and
calculate a third distance corresponding to a distance between the first data subset and the second data subset, and to generate an estimation distance information which is information capable of estimating a fourth distance corresponding to a distance between the first data set and the second data set based on the first distance, the second distance, and the third distance.

2. The information processing device according to claim 1, wherein the processor calculates a difference value corresponding to an index which represents a magnitude of a difference between the third distance and the fourth distance by calculating the first distance and the second distance.

3. The information processing device according to claim 1, wherein processor generates, as the estimation distance information, information indicating that a lower limit value of the fourth distance is a value acquired by subtracting the difference value from the third distance and an upper limit value of the fourth distance is a value acquired by adding the difference value to the third distance.

4. The information processing device according to claim 2, wherein the processor generates when the difference value is less than a threshold value, and generates a message to prompt at least one of a person who owns the first data subset or a person who owns the second data subset to re-create a data subset when the difference value is equal to or greater than the threshold value.

5. An information processing method comprising:
acquiring a first data subset created by extracting a partial data group included in a first data set, a first distance corresponding to a distance between the first data subset and the first data set, a second data subset created by extracting a partial data group included in a second data set, and a second distance corresponding to a distance between the second data subset and the second data set; and
calculating a third distance corresponding to a distance between the first data subset and the second data subset, and generating an estimation distance information which is information capable of estimating a fourth distance corresponding to a distance between the first data set and the second data set based on the first distance, the second distance, and the third distance.

6. A non-transitory computer-readable recording medium storing a program, the program causing a computer to perform a process comprising:
acquiring a first data subset created by extracting a partial data group included in a first data set, a first distance corresponding to a distance between the first data subset and the first data set, a second data subset created by extracting a partial data group included in a second data set, and a second distance corresponding to a distance between the second data subset and the second data set; and
calculating a third distance corresponding to a distance between the first data subset and the second data subset, and generating an estimation distance information which is information capable of estimating a fourth distance corresponding to a distance between the first data set and the second data set based on the first distance, the second distance, and the third distance.
